(19) United States
(12) Patent Application Publication
(10) Pub. No.: US 2016/0116360 A1
(43) Pub. Date: Apr. 28, 2016

(54) Portable Graphing Vacuum Pressure Gauge

(71) Applicant: Timothy G. Collins, Union Beach, NJ (US)

(72) Inventor: Timothy G. Collins, Union Beach, NJ (US)

(21) Appl. No.: 14/923,390

(22) Filed: Oct. 26, 2015

Related U.S. Application Data
(60) Provisional application No. 62/122,563, filed on Oct. 24, 2014.

(51) Int. Cl. G01L 21/12

(52) U.S. Cl. CPC G01L 21/12

(57) ABSTRACT

A portable vacuum pressure graphing gauge enabling users of vacuum systems the ability to see trends of vacuum systems through real time plotting of a pressure vs. time curve on a hand held instrument, enabling them to understand what is going on in their system, or the like. Additional features may include several graphical modes designed to even more easily interpret vacuum data, and packaging that is rugged and versatile including a magnet, kickstand, wireless connectivity, visual and audible set points, automatic sensor fault detection, and several vacuum pressure measurement units to choose from, or the like.

### CROSS-REFERENCE TO RELATED APPLICATIONS

The present application claims priority to U.S. Provisional Patent Application Ser. No. 62/122,563 entitled “PORTABLE GRAPHING VACUUM PRESSURE GAUGE,” filed Oct. 24, 2014, the disclosure of which is incorporated herein by reference in its entirety as if fully set forth herein.

### BACKGROUND

1. Field of the Invention

Embodiments of the present invention are in the field of portable vacuum pressure measurement. The present disclosure relates to a vacuum pressure gauge that has increased utility because it uses graphics that make it easy to spot trends or changes in vacuum. This gauge utilizes sensors and plots real time and historical data on a screen.

Embodiments of the present invention may include a device has the capability to show these trends via a hand held device or through communication to a mobile device or tablet to easily distinguish trends.

2. Description of Related Art

Most vacuum and pressure gauges display a current reading through an indicator needle against a scale, a digital numerical reading, voltage, or digital output. Typically, pressure and vacuum instrumentation offers a number indicating the current reading, and perhaps a bar graph of the instantaneous relative reading relative to the total range of the instrument.

Some vacuum instrumentation may indicate increasing or decreasing pressure, indicated by an up arrow, down arrow or colors. Other solutions do not include a time vs. pressure graph in a portable device, or a device with Ethernet capability. Other solutions may include a leak rate.

Other solutions may include pressure set points that allow the user to be notified when a particular pressure level is reached, but do not use Ethernet capability. The existing art does not have the ability to display, log or email vacuum data wirelessly to a smart phone, tablet, or the like. The most useful part of this vacuum system is its analytical capability and display of trends. Discovering trends in vacuum pressure allows the technician or engineer to be able to more quickly identify problems. Most professionals analyzing vacuum translate instantaneous readings in their head to establish trends that yield a result.

Other solutions require more complicated systems that requires data transfer, computers and software programs to analyze. This invention makes it easier for the technician or engineer to diagnose system state as it relates to vacuum.

### SUMMARY

Some embodiments of the present invention provide a vacuum pressure measurement and display device that greatly increases the utility of instrumentation through its real time display of current and past pressure points graphed in a time vs. pressure scale. The vacuum measurement circuitry reads the sensor, displays the instantaneous pressure and saves the data in a database. The data is then plotted on the screen. The amount of data plotted on the screen is user defined. Additional analysis modules within the device then characterize the trends of the data based on the user specified time horizon to make determinations on the vacuum system. These determinations may be: leaking, out-gassing, pumping or stable. Beyond these vacuum system determinations, the user may be able to see little “blips” of changes of pressure which may indicate other phenomena such as specific out-gassing events.

In another embodiment of the present disclosure, the device communicates wirelessly with a tablet, phone or other device for display to further increase the utility.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 shows the portable vacuum instrument with graphical display;

FIG. 2 shows the portable vacuum instrument in numerical mode, and the vacuum sensor;

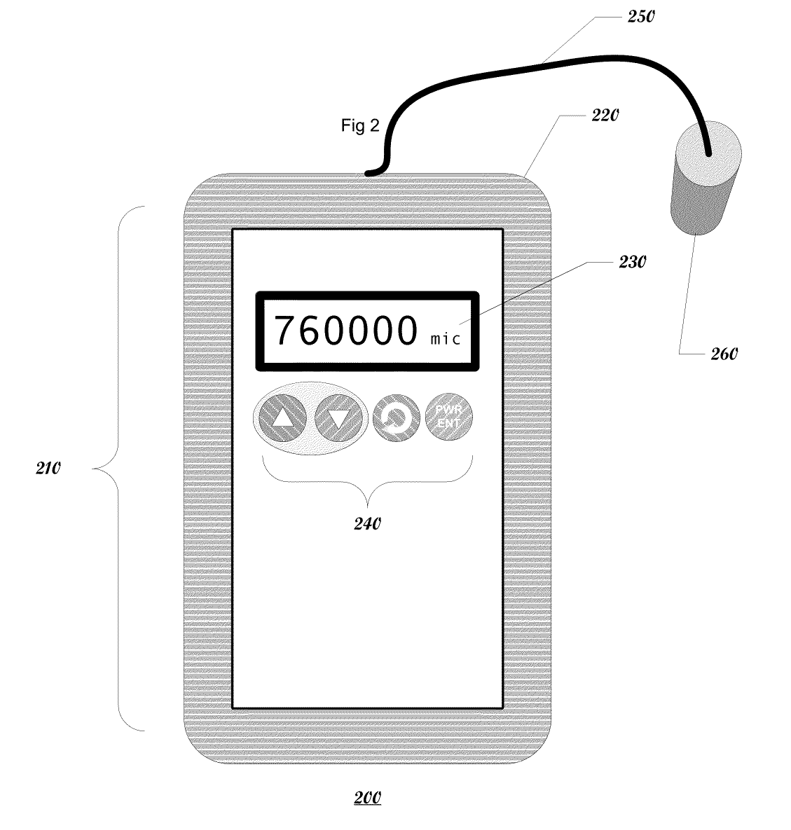

FIG. 3 summarizes the key hardware components in functional groups;

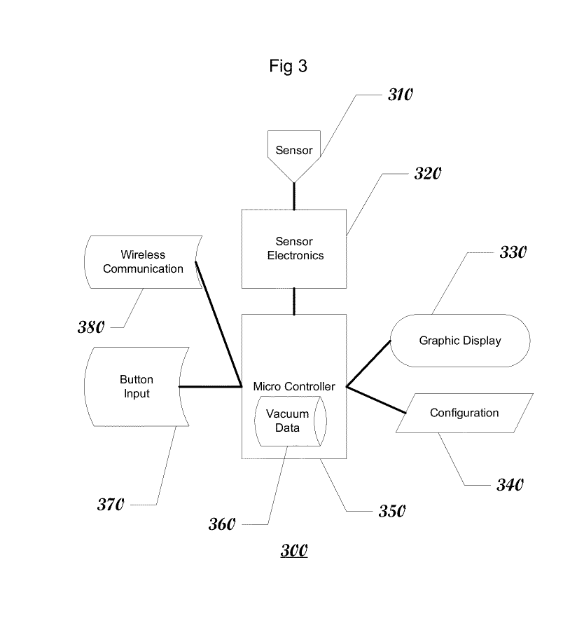

FIG. 4 summarizes the software architecture residing within the micro-controller; and

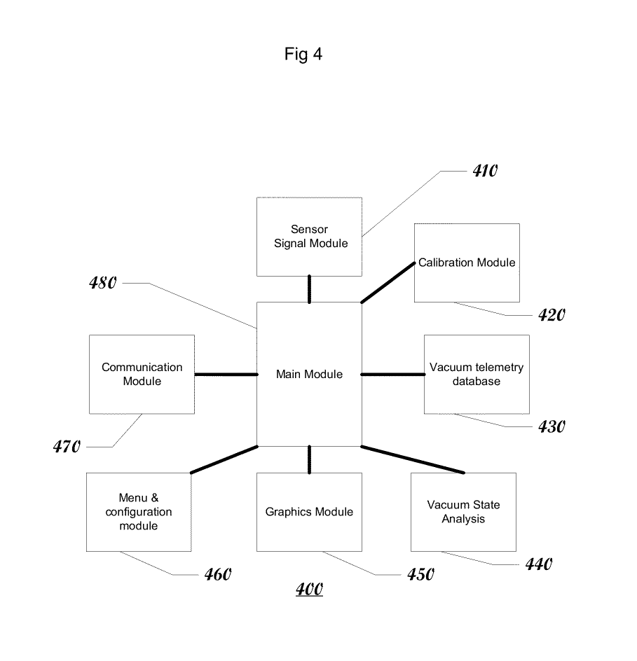

FIG. 5 presents the communication path of how vacuum data would be transferred to a user's personal device, and then wirelessly to their email through the internet.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Detailed embodiments of the present invention are disclosed herein; however it is to be understood that the disclosed embodiments are merely exemplary of the invention which can be embodied in various forms. The preferred embodiment of this invention is a portable device that senses pressure or vacuum through the use of a transducer or passive gauge, and has the electronics and software to interpret that reading into a number that indicates vacuum. The electronics enclosure 110 includes a graphical display 130 that may be back-lit. The current embodiment employs thermocouple sensing technology 220 connected to the gauge display 210 through a wire 250, but other equivalent embodiments could include thermistor, Pirani, convection, piezoresistive or other vacuum sensing technologies. In alternative embodiments the sensor, electronics and display may share the same housing. This embodiment is housed in a plastic case with a rubber protective boot, has 140 4 buttons for configuration, a kick stand and a magnet.

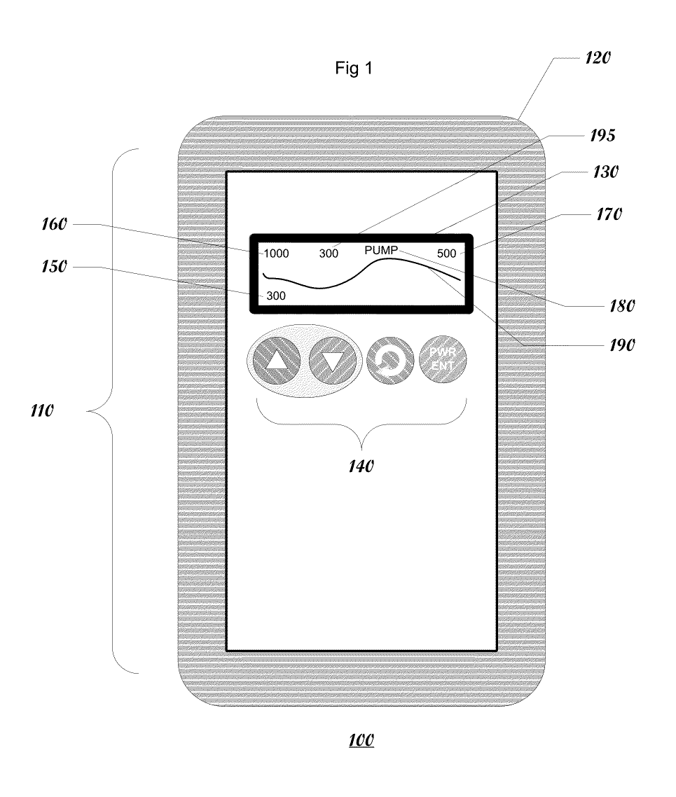

Some embodiments of this invention may have a different input mechanism to change features, may include a hook and may not include a kickstand or a magnet. The key benefit of the preferred embodiment of this invention is the inclusion of a real time graphing feature 190 that greatly accentuates the usefulness of portable technology. This embodiment also displays 130 additional graphing features including a zoom graphing feature 190, pictured in FIG. 1, a pump-down graph that is a continuous bar graph, an instantaneous bar graph and numerical values 230. In all modes, the current vacuum reading 170 is displayed. Other embodiments of this invention may only have 1 graphing mode. In this embodiment, this invention displays a zoom graphing feature where the pressure (vertical Y) axis will be automatically scaled by using the lowest number 150 in the time window as the lowest pressure value, and the highest pressure 160 in the time window as the highest pressure value on the (vertical) Y axis. The rate of change of vacuum is displayed 195 and calculated by averaging a recent portion of the latest vacuum data within the time window selected. Other embodiments of this invention may include different bounds for the Y axis pressure variables. The interpretation of the rate of vacuum change and curve shape determines the system state 180 determination. Alternative embodiments of this invention may include additional or other system state analysis determinations. The user can select between up to 12 different units, but alternate embodiments may include more or a subset of these pressure measurement unit choices. The user may select 1 of several discrete time windows including 1 minute, 10 minutes, 30 minutes, 1 hour and 24 hours, however alternate embodiments may include more, less or different time windows.

The electronics 300 is composed of different functional units, each of which is composed with a variety of discrete components with the resultant function. The sensor in this embodiment is a passive thermocouple vacuum gauge sensor. The sensor electronics 320 is composed of constant temperature regulating electronics combined with cycling electronics which are piped into the micro-controller 350 for further processing. The resultant measurement is converted to the appropriate measurement units and is sent to the graphic display 330 and stored in the database 360. The user may select to alarm at a particular vacuum level, time durations, units, auto off timing and several other features through the button input 370. These configuration settings are stored in persistent storage via the configuration memory 340. If so equipped, the user may transfer the data real time to a tablet, cell phone or other personal device via the wireless communication circuitry.

The software architecture 400 is comprised of a main module 480 that calls other modules, or polls data of other modules based on interrupts. The sensor module 410 takes the hardware massaged signal and does further post processing and delivers this value to the main module. The calibration module 420 is called when the vacuum sensor needs to be calibrated. Once the data is ready to be displayed, the main module sends the data to the graphics module 450 and the vacuum telemetry database 430. The vacuum state analysis module 440 is constantly working and when sufficient data based on the selected time window exists, an analysis is presented to the main module for display. This analysis is continuously recalculated based on the latest data. When the user wishes to change a configuration setting, the menu and configuration module 460 is called. The communication module 470 is used to transmit data from the gauge wirelessly to the outside world.

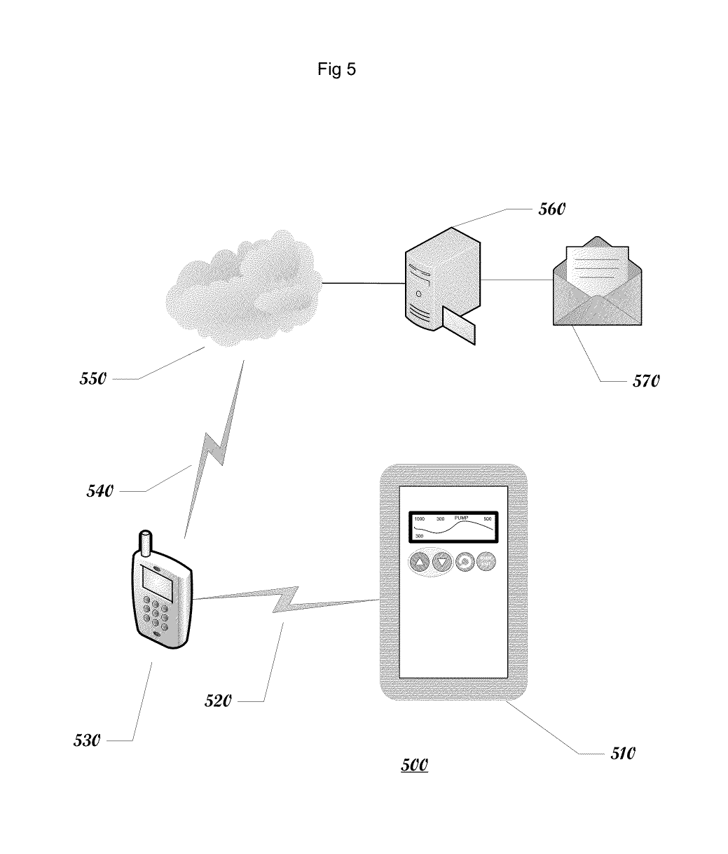

FIG. 5 shows a preferred embodiment of delivering the vacuum data to the outside world. The electronics enclosure 510 can transmit wirelessly 520 to a smart phone, tablet 530 or other commercially available personal device. The personal device may run an App to collect and display the current vacuum reading. This App also would be able to collect and transmit 540 the data to another destination 560 via email 570 or other data transfer mechanism through the cloud 550.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional components, as particular applications may require.

What is claimed is:

1. A portable vacuum instrument comprising:
a display adapted to display a graph in real time of collected data.

2. The instrument of claim 1, further comprising a transmitter that wirelessly transmits to a personal device.

3. The instrument of claim 2, wherein the personal device is a tablet computer or smartphone.

4. The instrument of claim 3, wherein the personal device includes an set of commands that, when executed, cause the instrument to communicate with the personal device for easy connectivity and display on the personal device.

5. The instrument of claim 1, wherein the instrument is adapted to communicate transmit data through email or other data exchange mechanism.

6. The instrument of claim 1, wherein the instrument is battery powered, solar powered, or wall powered.
